(19) United States
(12) Patent Application Publication
(10) Pub. No.: US 2012/0154374 A1
(43) Pub. Date: Jun. 21, 2012

(54) 3D IMAGE CONVERSION SYSTEM

(75) Inventors: Chuan-Hung CHENG, Tauyuan (CN); Kuen-Yi Chiang, Tauyuan (CN)

(73) Assignee: DA2 Technologies Corporation, Xizhi City (TW)

(21) Appl. No.: 12/969,658

(22) Filed: Dec. 16, 2010

(51) Int. Cl. G06T 15/00

(52) U.S. Cl. 345/419

(57) ABSTRACT

A 3D image conversion system is disclosed. A 3D image signal is input via HDMI to a field programmable gate array for conversion. The result is output via HDMI to a 3D display. By converting the 3D image signal into checkboard, field/frame sequential, or line interlaced signal, the invention enables a DLP, PDP, or LCD 3D display etc. to support several 3D image structure.

### BACKGROUND OF THE INVENTION

1. Field of Invention

The invention relates to a 3D image conversion system and, in particular, to a system for DLP, PDP, or LCD display etc. and converting several 3D image formats into checkboard, field/frame sequential, or line interlaced signals for output.

2. Related Art

With the advance in movie technology, various companies have their own 3D image formats. Currently, the High-Definition Multimedia Interface (HDMI) Association 1.4a defines shall support mendotary three major 3D structure for HDMI sink end.

The first is the 3D frame-packing structure technology used in blue-ray 3D images. This technology overlaps the images seen by the left and right eyes for display and transmissions.

The second is the 3D side-by-side structure used for broadcasting 3D images. This technology displays and transmits the images seen by left and right eyes in a side-by-side way.

The third is the top-and-bottom structure used for broadcasting 3D images. This technology displays and transmits the images seen by left and right eyes from top to bottom.

The so-called 3D image checkboard structure displays the images seen by the left and right eyes are displayed in each pixel in an interlaced way. It is used in earlier DLP 3D displays. The DLP 3D display can support the 3D checkboard structure. In order for the DLP 3D display to support HDMI-defined 3D structure, a conversion system is required.

As to the field/frame sequential or line interlaced formats, images seen by left and right eyes are sequentially interlaced in each frame or line. They are used in liquid crystal or plasma 3D displays etc. In order for the liquid crystal or plasma 3D displays etc. to support the HDMI-defined 3D structure, again, a conversion system is required.

### SUMMARY OF THE INVENTION

The invention provides a 3D image conversion system that involves the following steps. A 3D image signal is input via HDMI transmission to a field programmable gate array (FPGA) for conversion. The results are then output via the HDMI transmissions to a DLP 3D display. The FPGA include: a image input unit, a image control unit, and a image output unit

The image input unit separates the input 3D images into those seen by left and right eyes using a demuxer. The result is transmitted to the image control unit.

The image control unit uses a conversion formula to store the 3D image data in second-generation double-speed dynamic random access memory (DDRII). It converts the 3D image structure into the 3D image checkboard, field/frame sequential, or line-interlaced structure. The result is output to the image output unit.

The image output unit uses a muxer to combine the image signal converted by the image control unit to the checkboard, field/frame sequential, or line interlaced structure. The result is output via the HDMI transmissions.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a block diagram of the disclosed 3D image conversion system;

FIG. 2 is a block diagram of the disclosed field programmable gate array (FPGA);

FIG. 3 is the left-eye image in the 3D image frame-packing structure;

FIG. 4 is the right-eye image in the 3D image frame-packing structure;

FIG. 5 is an embodiment of converting the frame-packing structure into the checkboard structure according to the invention;

FIG. 6 shows the left-eye and right-eye images in the 3D image side-by-side structure;

FIG. 7 is an embodiment of converting the side-by-side structure into the checkboard structure according to the invention;

FIG. 8 shows the left-eye and right-eye images in the 3D image top-and-bottom structure;

FIG. 9 is an embodiment of converting the top-and-bottom structure into the checkboard structure according to the invention;

FIG. 10 shows the configuration of 3D image data in DDRII according to the invention;

FIG. 11 is a schematic view of the algorithm for image control of the disclosed 3D image conversion system;

FIGS. 12-15 show the I/O states of memory for the odd-numbered and even-numbered lines in frames 1-4 when converting the image into the checkboard structure;

FIGS. 16-19 show the I/O states of memory for the odd-numbered and even-numbered lines in frames 1-4 when converting the image into the field/frame sequential structure; and

FIGS. 20-23 show the I/O states of memory for the odd-numbered and even-numbered lines in frames 1-4 when converting the image into the line-interlaced structure.

### DETAILED DESCRIPTION OF THE INVENTION

The present invention will be apparent from the following detailed description, which proceeds with reference to the accompanying drawings, wherein the same references relate to the same elements.

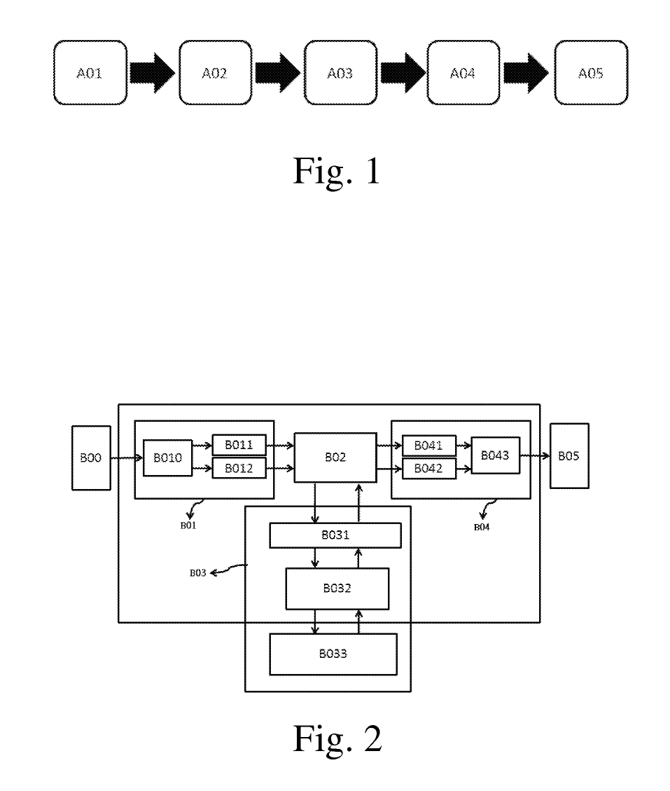

The disclosed 3D image conversion system involves the following steps. As shown in FIG. 1, a 3D image signal A02 is input via the HDMI A01 transmissions. After the conversion of a field programmable gate array (FPGA), the signal is output via the HDMI A4 to a DLP 3D display A05.

As shown in FIG. 2, the FPGA includes: an image input unit B01, an image control unit B02, and an image output unit B04.

The image input unit B01 enters a 3D image signal via HDMI B00. A image demuxer B010 separates image seen by left and right eyes into an odd-numbered pixel image and an even-numbered pixel image and temporarily stores them in an input odd-numbered pixel data buffer B011 and an input even-numbered pixel data buffer B012, respectively. The result is further transmitted to the image control unit B02.

The image control unit B02 uses a conversion formula to store the 3D image data in a DDRII B03. A corresponding conversion formula is used to convert the 3D image structure into a 3D image checkboard, field/frame sequential, or line interlaced structure. The result is output to the image output unit B04.

The image output unit B04 temporarily stores the odd-numbered pixel image and even-numbered pixel image converted and output by the image control unit B02 in an output odd-numbered pixel data buffer B041 and an output even-numbered pixel data buffer B042, respectively. An image muxer B043 then combines the images into an image signal in the 3D image checkboard, field/frame sequential, or line interlaced format. The result is output via HDMI B05 then.

There are three conversion methods for the image control unit of the 3D image conversion system.

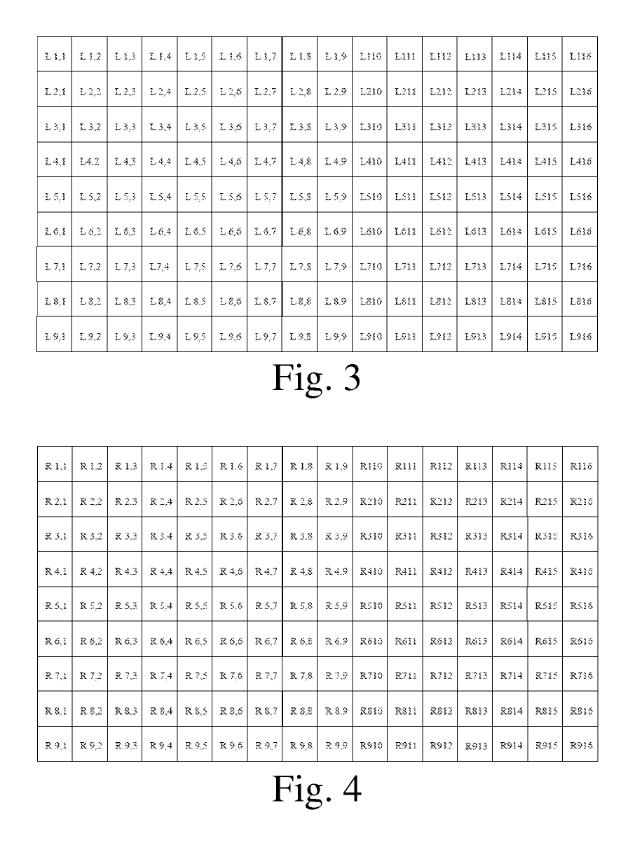

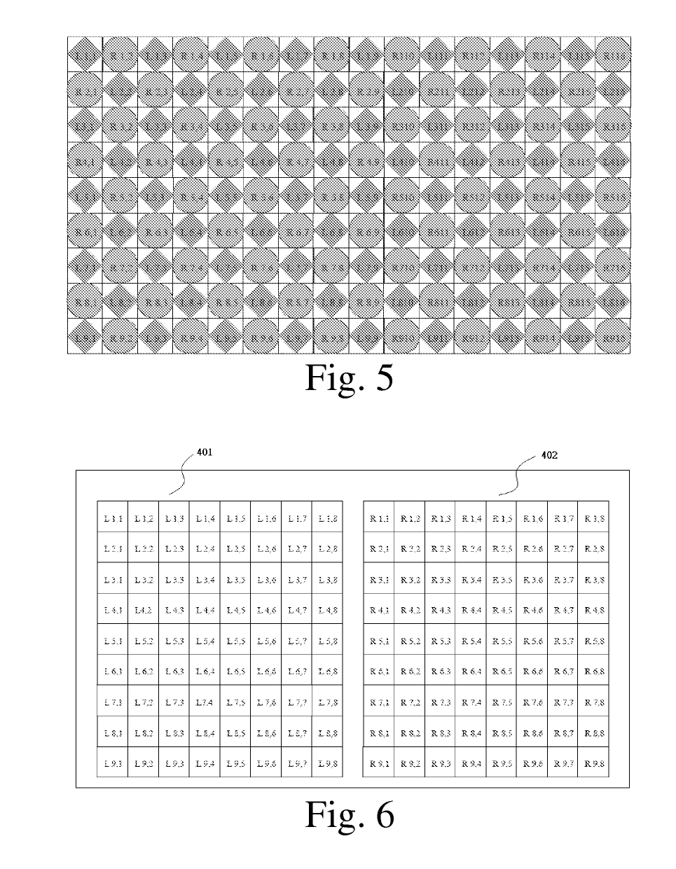

First, the 3D image frame-packing structure is converted into the 3D image checkboard format. The image seen by the left eye in FIG. 3 and the image seen by the right eye in FIG. 4 are converted and combined by the FPGA into the checkboard 3D image in FIG. 5.

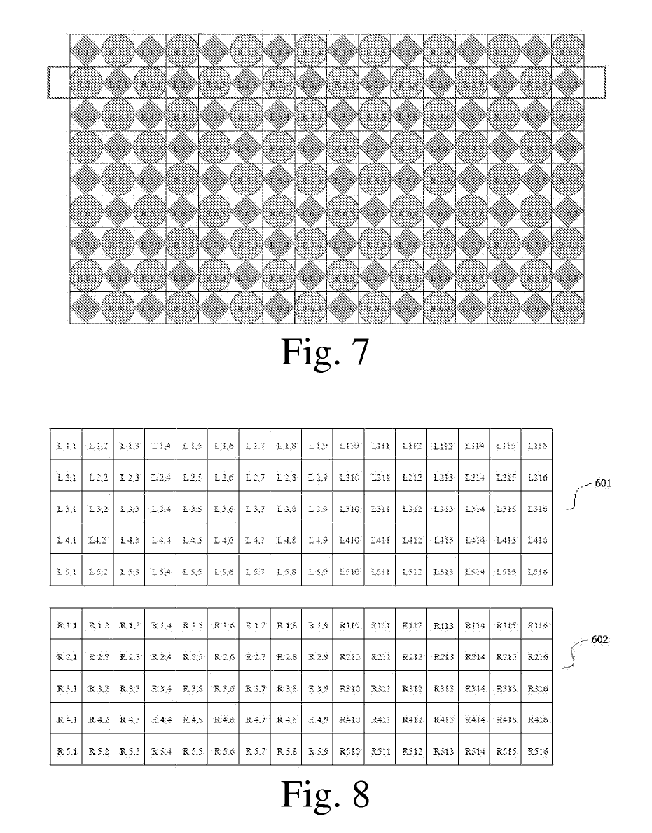

Secondly, the 3D image side-by-side structure is converted into the 3D image checkboard format. The image 401 seen by the left eye in FIG. 6 and the image 402 seen by the right eye in FIG. 4 are converted and combined by the FPGA into the checkboard 3D image in FIG. 7.

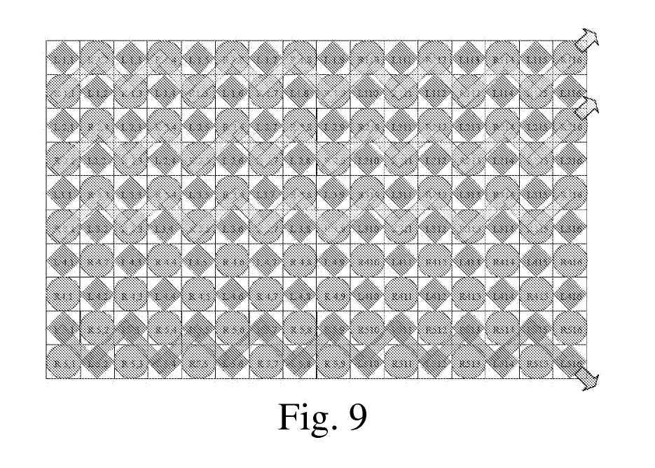

Thirdly, the 3D image top-and-bottom structure is converted into the 3D image checkboard format. The image 601 seen by the left eye and the image 602 seen by the right eye in FIG. 8 are converted and combined by the FPGA into the checkboard 3D image in FIG. 9.

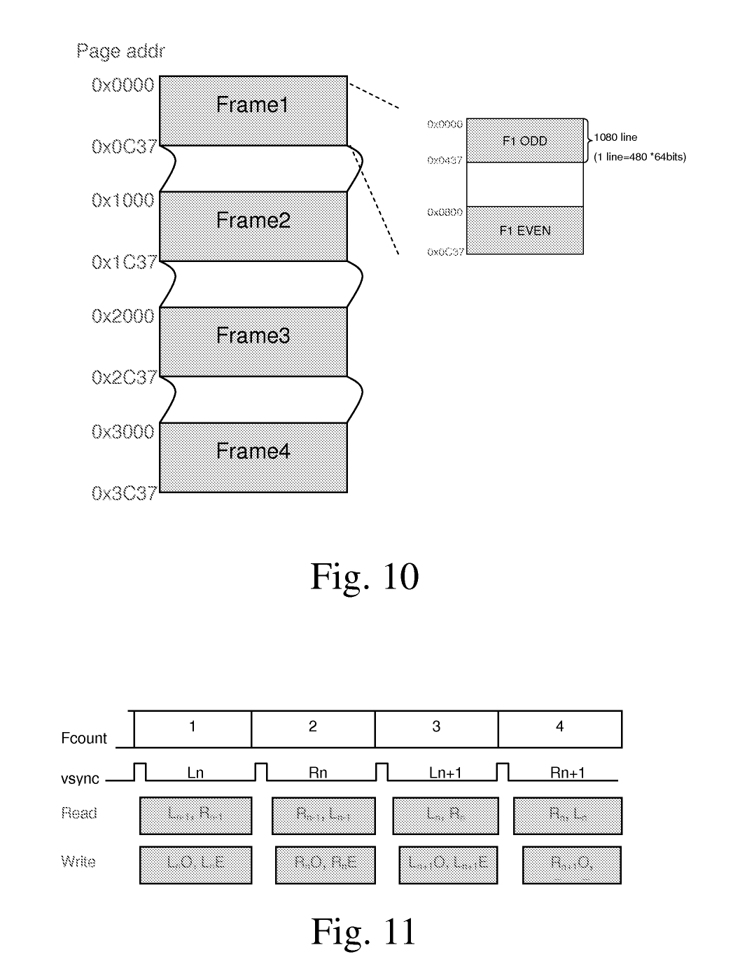

The 3D image data stored in the DDRII of the 3D image conversion system are shown in FIG. 10.

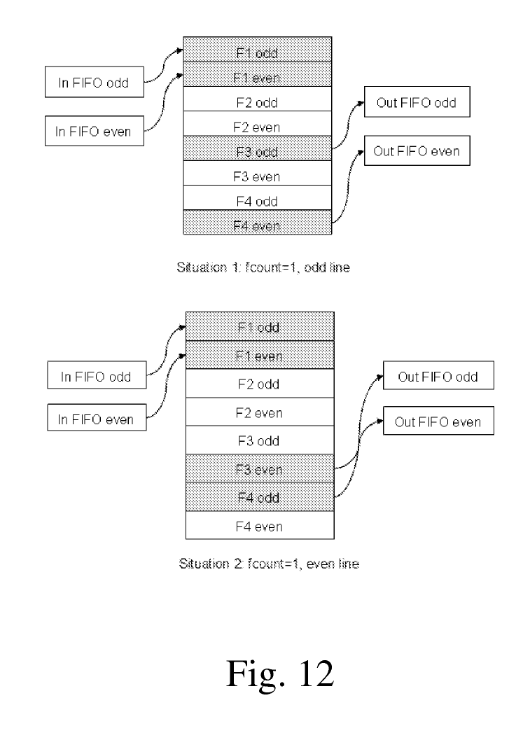

The algorithm used by the above-mentioned 3D image conversion system processing unit to convert the 3D image format into the checkboard, field/frame sequential, or line-interlaced structure is shown in FIG. 11. The checkboard, field/frame sequential, or line-interlaced structure is replaced by the converted image structure. FIGS. 12-15 show the input/output states of DDRII in the even-numbered and odd-numbered lines in field/frame 1-4.

DDRII is divided into four big temporary memory blocks, as shown in FIG. 10: frame 1, frame 2, frame 3, and frame 4. Data in each single frame consists of odd-numbered and even-numbered pixels in each line of the image. The FPGA follows the image control algorithm in FIG. 11 to access the DDRII, achieving the effects of converting the images.

The image control algorithm in FIG. 11 consists of four work time orders. The first time order Ln processes the odd-numbered and eve-numbered lines of image seen by left eye.

As shown in FIG. 12, the action of processing the odd-numbered lines of images seen by the left eye involves four steps. First, the odd-numbered pixels in each line of the left-eye image to be converted are read out from the data buffer and written into the temporary memory block of DDRII for the odd-numbered pixels in frame 1. Secondly, the even-numbered pixels in each line of the left-eye image to be converted are read out from the data buffer and written into the temporary memory block of DDRII for the even-numbered pixels in frame 1. Thirdly, the odd-numbered pixel data in frame 3 are read out from temporary memory block of DDRII and written into the odd-numbered pixel data buffer. Finally, the even-numbered pixel data in frame 4 are read out from temporary memory block of DDRII and written into the even-numbered pixel data buffer.

The action of processing even-numbered lines of images seen by the left eye also involves four steps. First, the odd-numbered pixels in each line of the left-eye image to be converted are read out from the data buffer and written into the temporary memory block of DDRII for the odd-numbered pixels in frame 1. Secondly, the even-numbered pixels in each line of the left-eye image to be converted are read out from the data buffer and written into the temporary memory block of DDRII for the even-numbered pixels in frame 1. Thirdly, the odd-numbered pixel data in frame 4 are read out from temporary memory block of DDRII and written into the odd-numbered pixel data buffer. Finally, the even-numbered pixel data in frame 3 are read out from temporary memory block of DDRII and written into the even-numbered pixel data buffer. This completes the actions in the first time order Ln.

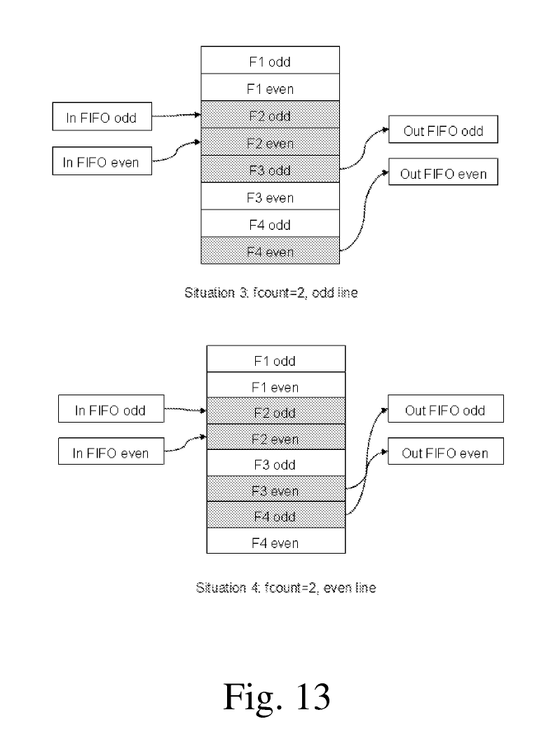

The second time order Rn processes odd-numbered lines and even-numbered lines of images seen by the right eye. As shown in FIG. 13, the action of processing the odd-numbered lines of images seen by the right eye. First, the odd-numbered pixels in each line of the right-eye image to be converted are read out from the data buffer and written into the temporary memory block of DDRII for the odd-numbered pixels in frame 2. Secondly, the even-numbered pixels in each line of the right-eye image to be converted are read out from the data buffer and written into the temporary memory block of DDRII for the even-numbered pixels in frame 2. Thirdly, the odd-numbered pixel data in frame 3 are read out from temporary memory block of DDRII and written into the odd-numbered pixel data buffer. Finally, the even-numbered pixel data in frame 4 are read out from temporary memory block of DDRII and written into the even-numbered pixel data buffer.

The action of processing even-numbered lines of images seen by the right eye also involves four steps. First, the odd-numbered pixels in each line of the right-eye image to be converted are read out from the data buffer and written into the temporary memory block of DDRII for the odd-numbered pixels in frame 2. Secondly, the even-numbered pixels in each line of the right-eye image to be converted are read out from the data buffer and written into the temporary memory block of DDRII for the even-numbered pixels in frame 2. Thirdly, the odd-numbered pixel data in frame 4 are read out from temporary memory block of DDRII and written into the odd-numbered pixel data buffer. Finally, the even-numbered pixel data in frame 3 are read out from temporary memory block of DDRII and written into the even-numbered pixel data buffer. This completes the actions in the second time order Rn.

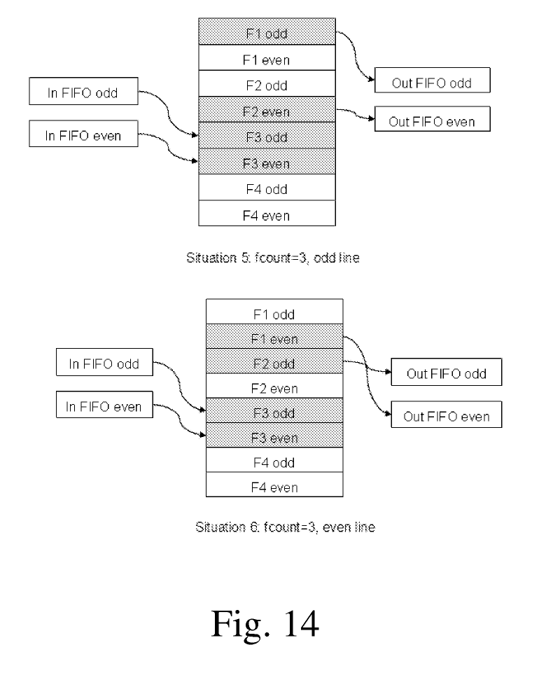

The third time order Ln+1 processes the odd-numbered and even-numbered lines of images seen by the left eye. As shown in FIG. 14, the action of processing the odd-numbered lines of images seen by the left eye involves four steps. First, the odd-numbered pixels in each line of the left-eye image to be converted are read out from the data buffer and written into the temporary memory block of DDRII for the odd-numbered pixels in frame 3. Secondly, the even-numbered pixels in each line of the left-eye image to be converted are read out from the data buffer and written into the temporary memory block of DDRII for the even-numbered pixels in frame 3. Thirdly, the odd-numbered pixel data in frame 1 are read out from temporary memory block of DDRII and written into the odd-numbered pixel data buffer. Finally, the even-numbered pixel data in frame 2 are read out from temporary memory block of DDRII and written into the even-numbered pixel data buffer.

The action of processing even-numbered lines of images seen by the left eye also involves four steps. First, the odd-numbered pixels in each line of the left-eye image to be converted are read out from the data buffer and written into the temporary memory block of DDRII for the odd-numbered pixels in frame 3. Secondly, the even-numbered pixels in each line of the left-eye image to be converted are read out from the data buffer and written into the temporary memory block of DDRII for the even-numbered pixels in frame 3. Thirdly, the odd-numbered pixel data in frame 2 are read out from temporary memory block of DDRII and written into the odd-numbered pixel data buffer. Finally, the even-numbered pixel data in frame 1 are read out from temporary memory block of DDRII and written into the even-numbered pixel data buffer. This completes the actions in the third time order Ln+1.

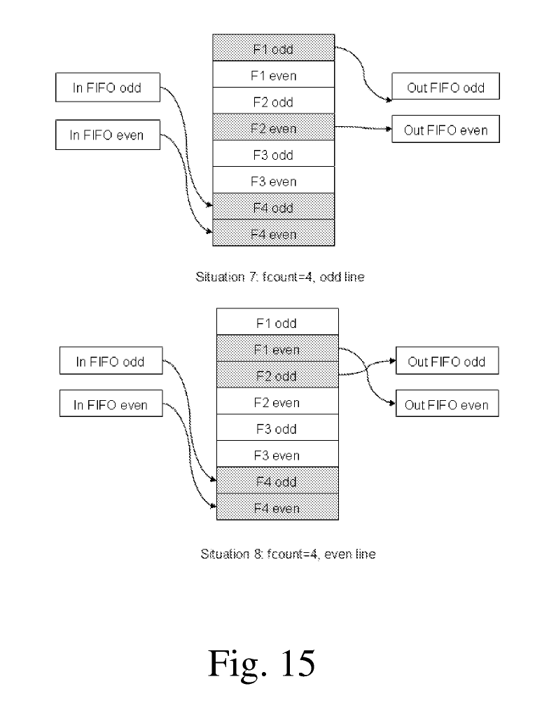

The fourth time order Rn+1 processes odd-numbered lines and even-numbered lines of images seen by the right eye. As shown in FIG. 15, the action of processing the odd-numbered lines of images seen by the right eye. First, the odd-numbered pixels in each line of the right-eye image to be converted are read out from the data buffer and written into the temporary memory block of DDRII for the odd-numbered pixels in frame 4. Secondly, the even-numbered pixels in each line of the right-eye image to be converted are read out from the data buffer and written into the temporary memory block of DDRII for the even-numbered pixels in frame 4. Thirdly, the odd-numbered pixel data in frame 1 are read out from temporary memory block of DDRII and written into the odd-numbered pixel data buffer. Finally, the even-numbered pixel data in frame 2 are read out from temporary memory block of DDRII and written into the even-numbered pixel data buffer.

The action of processing even-numbered lines of images seen by the right eye also involves four steps. First, the odd-numbered pixels in each line of the right-eye image to be converted are read out from the data buffer and written into the temporary memory block of DDRII for the odd-numbered pixels in frame 4. Secondly, the even-numbered pixels in each line of the right-eye image to be converted are read out from the data buffer and written into the temporary memory block of DDRII for the even-numbered pixels in frame 4. Thirdly, the odd-numbered pixel data in frame 2 are read out from temporary memory block of DDRII and written into the odd-numbered pixel data buffer. Finally, the even-numbered pixel data in frame 1 are read out from temporary memory block of DDRII and written into the even-numbered pixel data buffer. This completes the actions in the second time order Rn+1.

The FPGA repeats the above-mentioned time-ordered actions to achieve the goal of converting image into the checkboard structure.

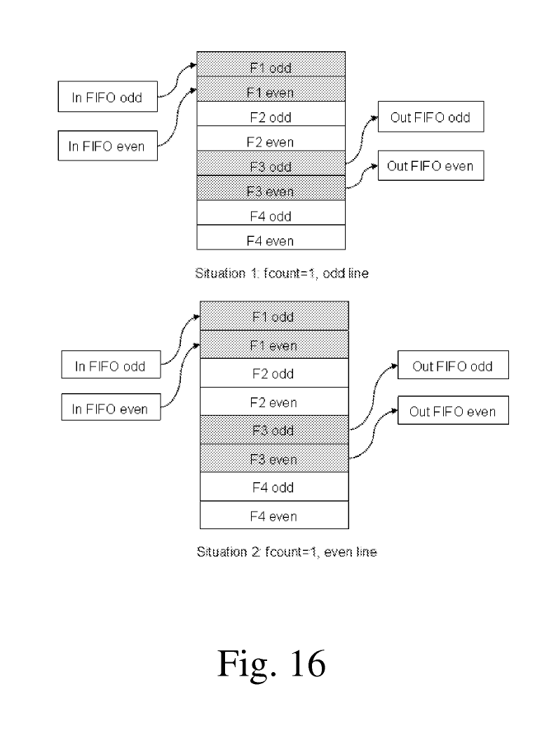

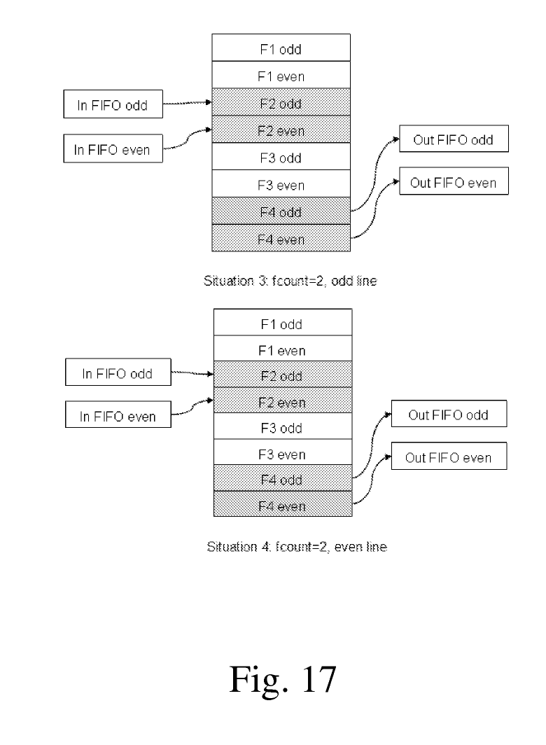

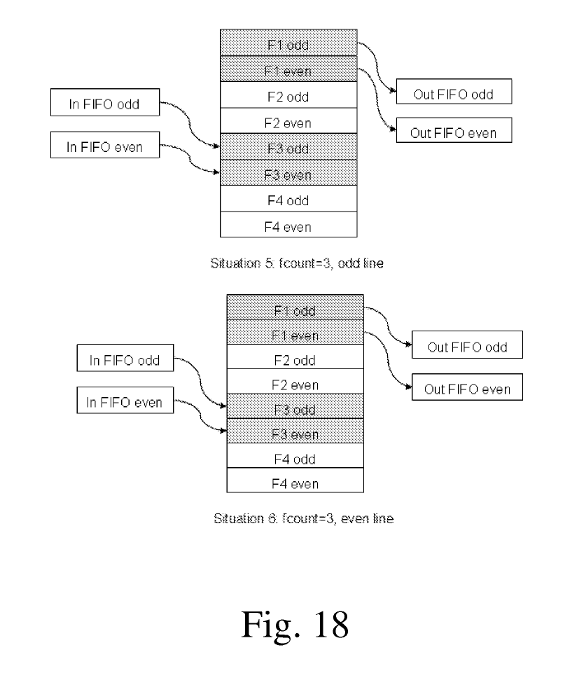

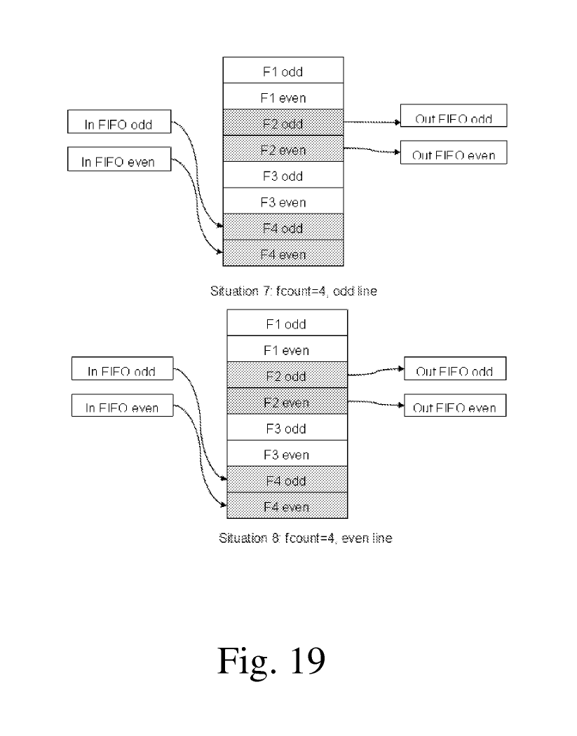

Likewise, the FPGA repeats the time-ordered actions in FIGS. 16-19 to achieve the goal of converting image into the field/frame sequential structure.

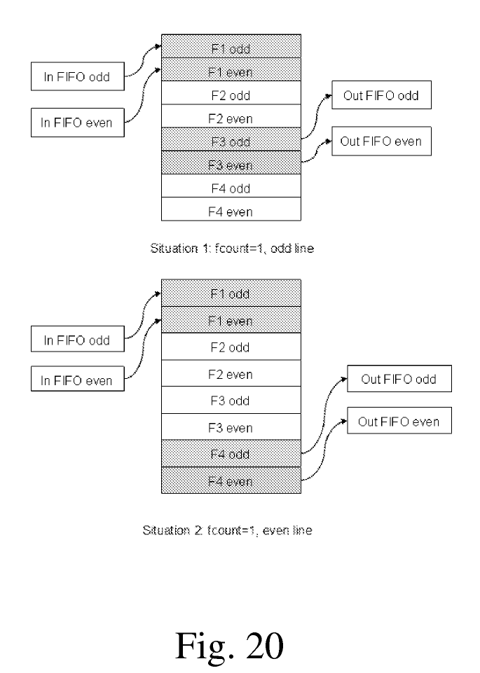

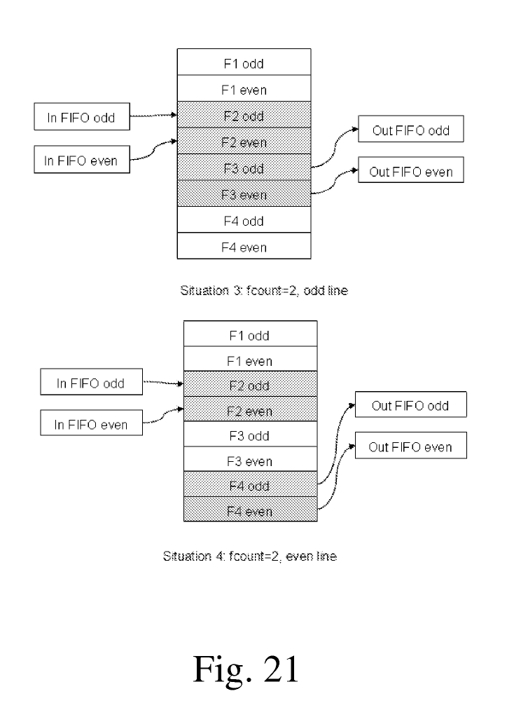

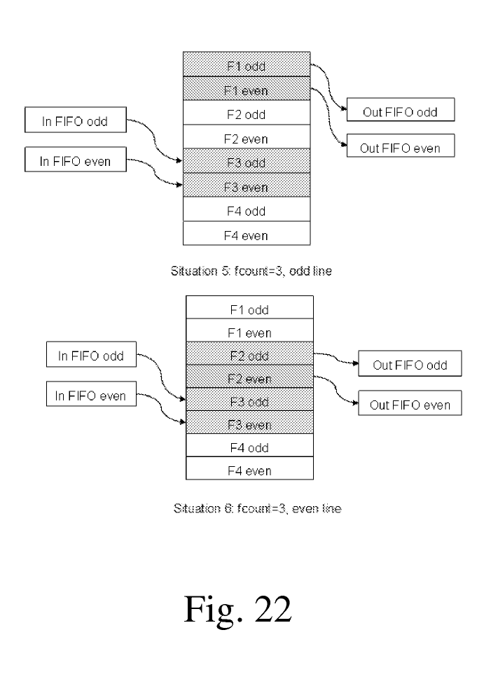

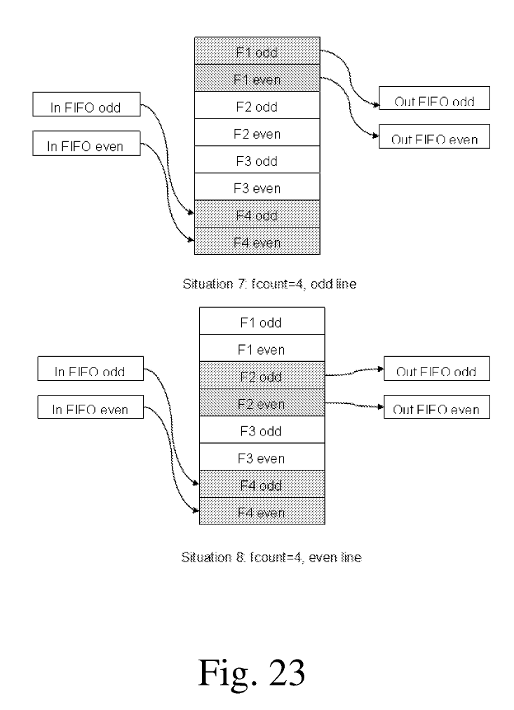

Alternatively, the FPGA repeats the time-ordered actions in FIGS. 20-23 to achieve the goal of converting image into the line-interlaced structure.

The input and output units of the above-mentioned 3D image conversion system use the HDMI 1.4a transmission protocol as the 3D image transmission interface.

Although the invention has been described with reference to specific embodiments, this description is not meant to be construed in a limiting sense.

Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A three-dimensional (3D) image conversion system for transmitting an image via a 3D image input unit to a field programmable gate array (FPGA) for conversion and transmitting the converted result via a 3D image output unit to a 3D, the FPGA comprising an image input unit, an image control unit, and an image output unit; wherein
the image input unit receives a 3D image via High-Definition Multimedia Interface (HDMI), separates left-eye and right-eye images thereof to an odd-numbered pixel image and an even-numbered pixel image using a demuxer, and transmits the odd-numbered pixel image and the even-numbered pixel image to the image control unit;
the image control unit uses a conversion formula to store the 3D image data into a second-generation double-speed dynamic random access memory (DDRII), uses a corresponding conversion formula to convert a plurality of 3D image structure into a 3D image checkboard structure, field/frame sequential structure, or line-interlaced structure, and outputs the converted structure to the image output unit; and
the image output unit combines the odd-numbered pixel image and the even-numbered pixel image using a muxer into the 3D image in the checkboard structure, field/frame sequential structure, or line-interlaced structure, and outputs the 3D image via HDMI.

2. The 3D image conversion system of claim 1, wherein the image control unit combines the left-eye and right-eye images into the checkboard image structure by alternately accessing the odd-numbered pixels and the even-numbered pixels in each line of the DDRII frame.

3. The 3D image conversion system of claim 1, wherein the image control unit combines the left-eye and right-eye images into the field/frame sequential image structure by alternately accessing the odd-numbered pixels and the even-numbered pixels in each line of the DDRII frame.

4. The 3D image conversion system of claim 1, wherein the image control unit combines the left-eye and right-eye images into the line-interlaced image structure by alternately accessing the odd-numbered pixels and the even-numbered pixels in each line of the DDRII frame.
